(19) United States
(12) Patent Application Publication
(10) Pub. No.: US 2011/0163534 A1
(43) Pub. Date: Jul. 7, 2011

(54) SOLAR HOT WATER STORAGE SYSTEM AND DUAL PASSAGEWAY FITTING ASSEMBLY

(76) Inventor: Vincent Peter Biel, Belleview, FL (US)

(21) Appl. No.: 12/683,496

(22) Filed: Jan. 7, 2010

(51) Int. Cl. F16L 7/00; B23P 19/04; B23P 15/26

(52) U.S. Cl. 285/123.1; 29/426.1; 29/726

(57) ABSTRACT

A dual passageway fitting assembly 10 for connection to a hot water tank 2 in a solar hot water system 200 is disclosed. The fitting assembly 10 has a fitting assembly that internally forms two isolated water passageways P₁ and P₂, a water outflow passageway and a hot water inflow passageway. The fitting assembly 10 has a connection end fitting 40 to connect water tightly to a single access port 4 on the hot water tank 2. The fitting assembly 10 enables a method of converting an electric hot water tank 2 having dual heating elements 80 to a solar hot water tank. The method includes the steps of: removing one of the heating elements 80; exposing a threaded access port 4 on the tank 2; and installing a dual passageway fitting assembly 10 to the threaded access port 4 of the tank 2.

### TECHNICAL FIELD

This invention relates to solar heated hot water systems generally and more particularly to a fitting assembly for converting a standard electric hot water tank to a solar powered hot water tank.

### BACKGROUND OF THE INVENTION

Heating water for use in bathing, washing clothes, cleaning dishes or operating a dish washer requires a separate heating unit to be used in the plumbing system of a residential house or commercial building.

Traditional water heating systems have used large holding tanks to heat and store the water. These large holding tanks heated the water with either natural gas heaters or electric heating elements. The most common water tanks employ two electric heating elements that are mounted through the side of the tank with a threaded end and connected to a electric power panel on the side of the tank wired to an electric power source. The outside of this standard hot water tank is covered with insulation and an outer shell holds the assembly together. On the top of the tank water lines are connected to an inlet fitting and a supply fitting. The hot water line is connected to plumbing to distribute hot water throughout the building. The tanks are further fitted with a pressure relief valve on the top and a water discharge port near the bottom for periodically flushing sediment build up within the tank.

These electric hot water systems hold and heat typically between 40 and 80 gallons of water and maintain the heated water at temperatures around 120 degrees F. or more. The electric power consumed can be a considerable expense, second only to air conditioning and whole house heating. To reduce these costs several more efficient systems of heating water have been attempted. One such system is solar hot water systems.

Solar hot water systems employ a solar collector mounted in a location where sunlight can heat water as it passes through one or more solar collectors. Typically the solar collectors are mounted on the roof of a building. The water is pumped through the system using a small, generally low flow pump that insures the water can be adequately heated in the solar collectors before it is sent to a solar hot water tank. These solar hot water tanks work in much the same way as a conventional or standard hot water tank, but it has two additional fittings on the top of the solar tank connected to lines for taking water from the tank to be heated by the solar collectors and returning hot water back to the solar tank.

The pumping system is controlled by temperature sensors that monitor the water temperature in the solar tank and shut off or restrict the flow to keep the water temperature in the desired range. At night or dusk the solar system pump is shut off to avoid cooling the water when no solar heat is available. The solar tanks often include auxiliary heating for maintaining the temperature of the water at night if needed.

Solar heated water holding tanks preferably store water heated up to 180 degrees F. A mixing valve is added to the hot water line which enables cold water to mix with the 180 degree F. water cooling it to about 120 degrees F. Thermostatic temperature controls on the mixing valve insure the right amount of cold water is mixed to control the temperature coming out of the faucet at 120 degrees F. This enables the solar heated tanks to hold water at higher temperatures than a standard electric hot water system without a mixing valve. The main difference is the hotter water comes at no added cost due to solar heating.

As can easily be appreciated the use of solar heated water eliminates the use of and demand for electricity in daylight hours meaning no electricity is used to heat water during peak demand times. This reduces energy consumption and helps reduce the cost of electricity. One major problem is the electricity savings are offset by rather expensive equipment costs. The additional cost of plumbing, solar collectors, pumps, controls and a solar tank means most users of hot water will not spend the money to install such a system.

The solar systems can cost $2,500 to well over $5,000 or more. One large cost is replacing or adding to the existing standard hot water tank. A solar tank costs $800 to $1,200. This expense when combined with the additional components required makes the initial expenditure so high that the pay back in cost savings takes many years.

The present invention provides a unique way to virtually eliminate the cost of a new water holding tank and enables a pre existing standard electric hot water tank to be adapted for use in combination with a solar collector system enabling solar heated water to be used with almost any conventional hot water storage system that uses electric heating elements.

### SUMMARY OF THE INVENTION

A fitting assembly for connection to a hot water tank in a solar hot water system is disclosed. The fitting assembly has a fitting assembly that internally forms two isolated water passageways, a water outflow passageway P₁ and a hot water inflow passageway P₂. The fitting assembly has a connection end fitting to connect water tightly to a single access port on the hot water tank, wherein the connection end fitting has a standard thread male end with integral nut having internal female pipe threads. The male end of the connection fitting connects directly to standard female threads on an access port on the side of a hot water tank. The fitting assembly has an O ring placed over the threaded male end to water tightly seal the connection end fitting to the water tank. The fitting assembly further has a first male threaded nipple fitting or threaded pipe fitting connected to the female threads of nut and has a “T” fitting having three ends, a connection end for connection to the first nipple or pipe fitting or the nut of the connection end fitting directly, a first end for connection to water outflow lines and a second end for hot water inflow lines. The fitting assembly further has an extended tube fitting, the extended tube fitting has a fitting end for connection to the second end of the T fitting and when assembled has a tube extend internal of the T fitting through the connection end fitting extending a distance (d) beyond the connection end fitting forming the hot water passageway. The second end of the T fitting has a smaller diameter than the connection end, and wherein the extended tube fitting has a threaded nipple or pipe end for attachment to the second end of the “T” fitting. The fitting assembly has an elbow fitting attached to the extended tube fitting at the second end of the “T” fitting. Alternatively, the extended tube fitting has a tube extended through the “T” fitting, the tube being connected to an elbow, the elbow being attached directly to the “T” fitting. The fitting assembly may include a first shut off valve attached to the first center end of the T and a second shut off valve is connected to the elbow, the extended tube fitting forms the second internal passageway P₂. The “T” fitting and end connection fitting form the first passageway P₁ encircling the second passageway P₂ inside the fitting assembly. The fitting assembly enables a method of converting an electric hot water tank having dual heating elements to a solar hot water tank. The method includes the steps of: removing one of the heating elements; exposing a threaded access port on the tank; and installing a dual passageway fitting assembly to the threaded access port of the tank. The method can further include the step of connecting the dual passageway fitting assembly to a solar collector and pump assembly and installing a mixing valve to the hot water line of the water tank to permit high temperature water to be delivered at about 120 degrees F.

### BRIEF DESCRIPTION OF THE DRAWINGS

FIG. 1 is a schematic view of a prior art solar hot water system connected to a solar hot water storage tank.

FIG. 2 is the schematic view taken from FIG. 1 wherein a standard electric hot water system has a dual passageway fitting assembly according to the present invention added permitting its use in a solar hot water system thereby eliminating the solar tank of FIG. 1.

FIG. 3 is an enlarged view showing the hot water tank with the dual passageway fitting assembly of the present invention installed.

FIG. 4 is a perspective view of the dual passageway fitting assembly according to the present invention.

FIG. 5 is an exploded view of the dual passageway fitting assembly of FIG. 4.

FIG. 6 is a cross sectional view of the assembled dual passageway fitting of FIG. 4.

FIG. 7 is an alternative embodiment of the fitting assembly of the present invention.

FIG. 8 is a second alternative embodiment of the fitting assembly of the present invention.

### DETAILED DESCRIPTION OF THE INVENTION

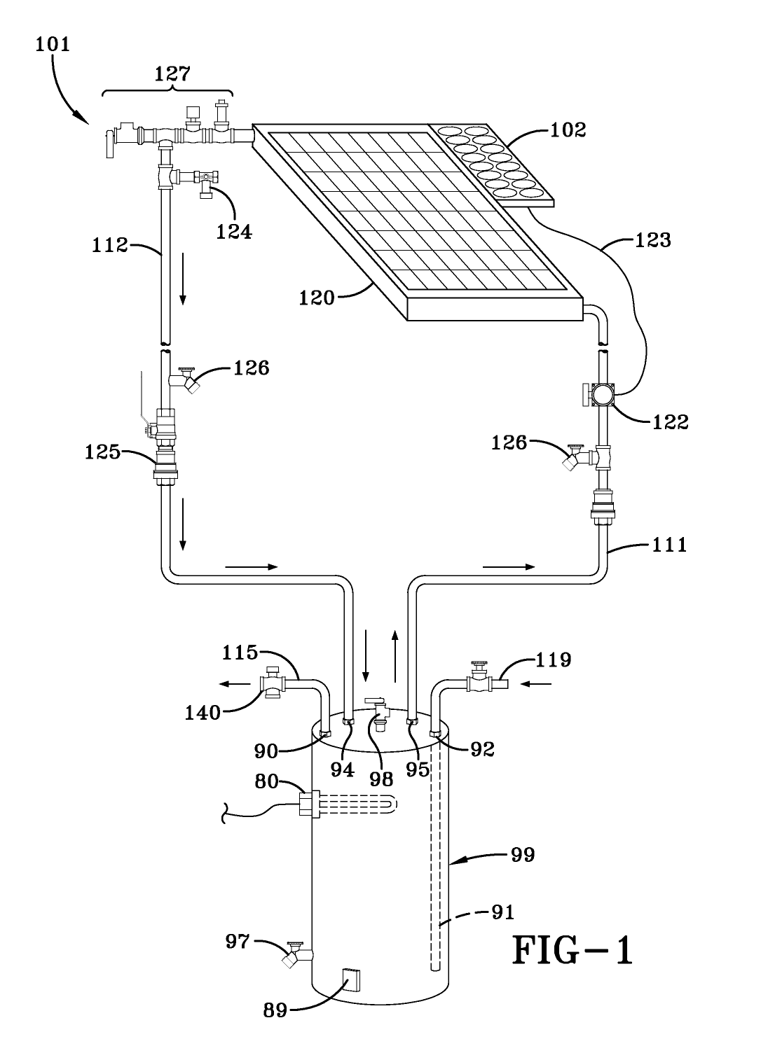

With reference to FIG. 1, a schematic view of a prior art solar hot water system 101 connected to a prior art solar hot water storage tank 99 is illustrated. The system 101 as illustrated is a direct open loop schematic solar hot water heating system. The direct pumped system 101 has one or more solar energy collectors 120 installed on the roof and a solar storage tank 99 somewhere below usually in a garage or utility room. A pump 122 circulates water from the tank 99 up to the collector 120 and back again. This is called a direct (or open loop) system because the sun's heat is transferred directly to the potable water circulating though the collector 120 to the storage tank 99; no antifreeze solution or heat exchanger is involved.

The system 101 as shown employs a photovoltaic (PV) cell 102 that senses when there is enough solar energy available to heat the home hot water. The PV cell 102 powers a DC pump 122 connected by wiring 123 which circulates the water from the solar storage tank 99 to the solar collector 120 at a rate of about 6 gallons per minute during peak solar hours, slightly slower rates on cloudy days with lower solar energy inputs.

A collection of valves 127 is connected to the line 112 for flow control and pressure relief and include a free flush type freeze protection valve 124 installed near the collector 120 provides freeze protection. Whenever temperatures approach freezing, the valve 124 opens to let warm water flow through the collector 120, the collector 120 also allows for manual draining by closing isolation valves 125 located above the storage tank 99 and opening the drain valve 126. As shown the storage holding tank 99 has four fittings at the top of the solar storage tank 99, one fitting 90 for allowing hot water out, one fitting 92 for allowing cold water in and as shown in dashed lines the cold water is distributed at the bottom of the tank through cold water fitting 92 to a tube 91 and two additional fittings, one fitting 94 provided for receiving hot water from the solar collector 120 and one fitting 95 for taking water from the storage tank 99 and delivering it to the solar collector via the circulating pump 122. The solar tank 99 has a conventional pressure relief valve 98 at the top of the unit as illustrated. Additionally, the tank 99 provides for a sediment drain 97 at the lower side and a tank sensor 89 to sense the temperature within the solar storage tank 99. Additionally, this solar hot water tank 99 includes an electric heating element 80 as illustrated. The heating element 80 provides for additional heating at times when the sun is not available such as at night. This schematic is one example of a currently available prior art solar heating system using a specialized solar storage tank 99.

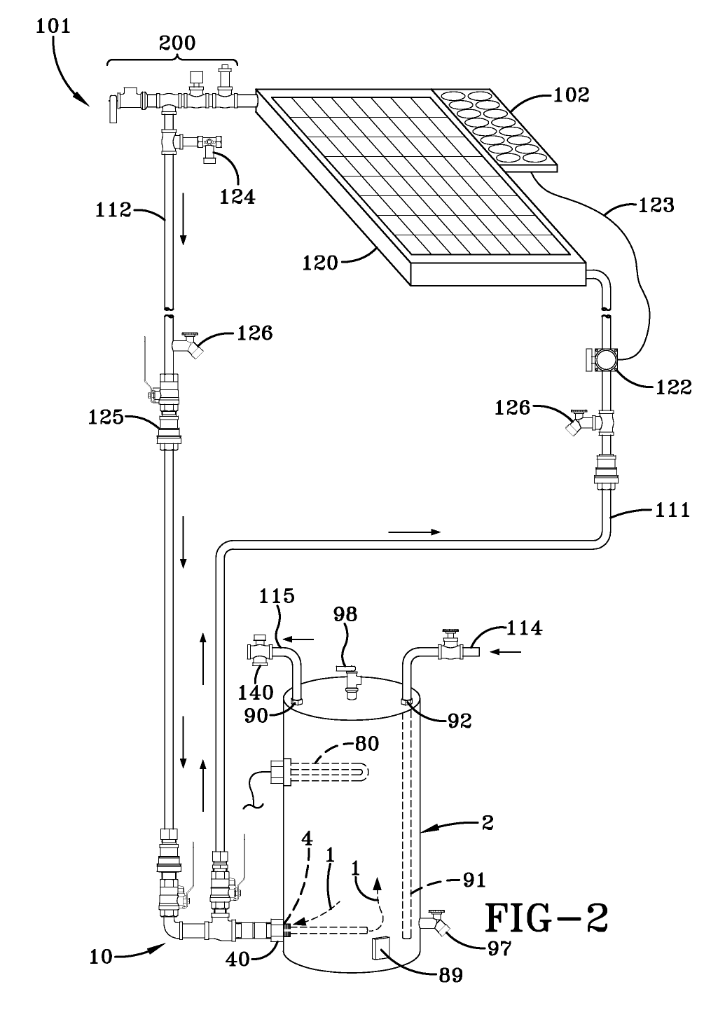

With reference to FIG. 2 a schematic view similar to that taken from FIG. 1 having many of the same components wherein a standard electric hot water storage tank 2 has had a dual passageway fitting assembly 10 made according to the present invention added to make it usable in a solar hot water system 200. As shown the standard electric hot water tank 2 has the solar system 200 connected at a lower threaded access port 4 where normally an electric heating element 80 would be installed. The lower electric heating element 80 (not shown) has been replaced and the dual passageway fitting assembly 10 has been attached to the tank 2 providing an access port 4 for water 1 from the tank 2 to be delivered to the solar collector 120, heated and returned back through the same port 4 to deliver solar heated hot water back into the storage tank 2. As shown there are no additional valves or fitting attachments required at the top of the tank 2 to make a connection to a solar collector 120. The standard two fittings 90, 92; one for cold water-in 92 and one for hot water-out 90 are still provided and work like they had previously done. On the hot water side a mixing valve 140 can be installed to enable 180 degree F. water to be used as previously discussed. By removing the lower heating element 80 from the threaded access port 4 on the tank 2 and installing the fitting assembly 10 to this threaded port 4 a dual water line connection is made available for both the delivery of water 1 from the tank 2 to the solar collector 120 and return the solar heated water from the solar collector 120 back to the tank 2 through the single access point 4 on the storage tank 2.

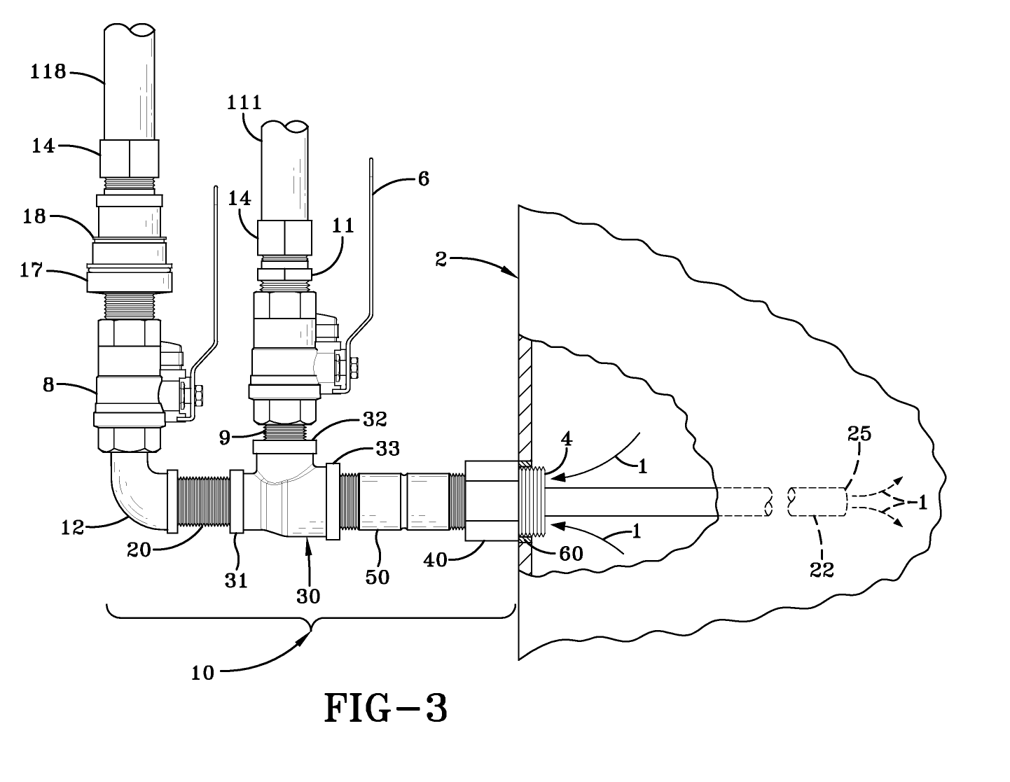

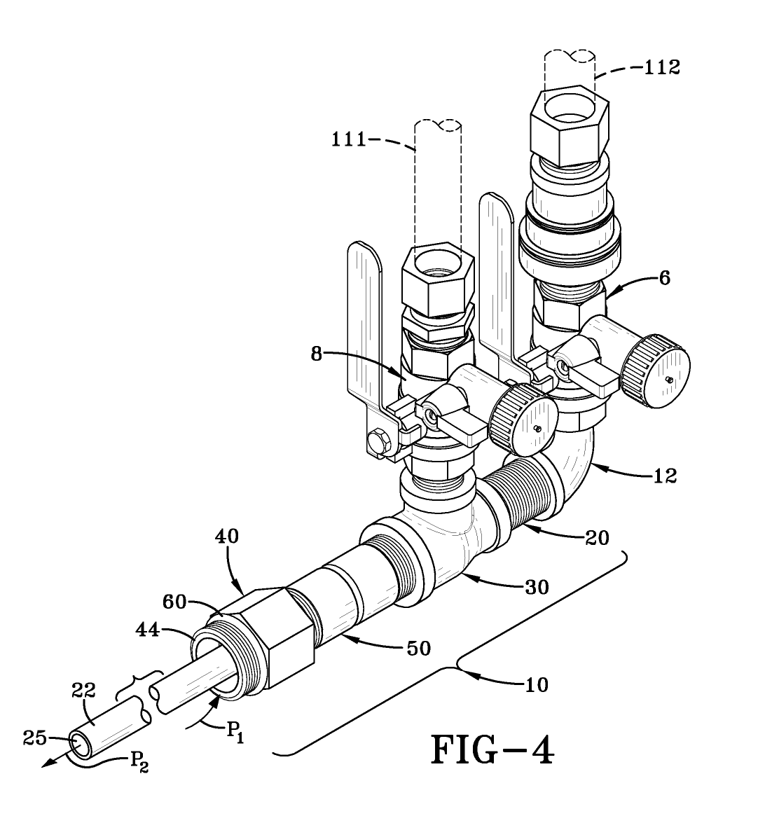

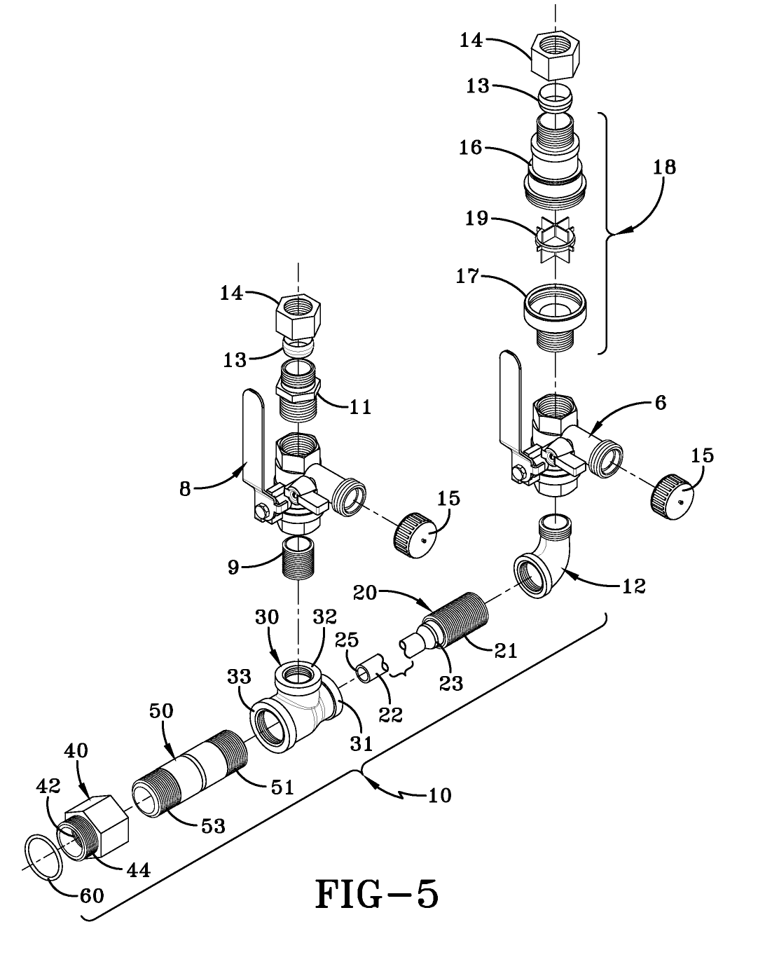

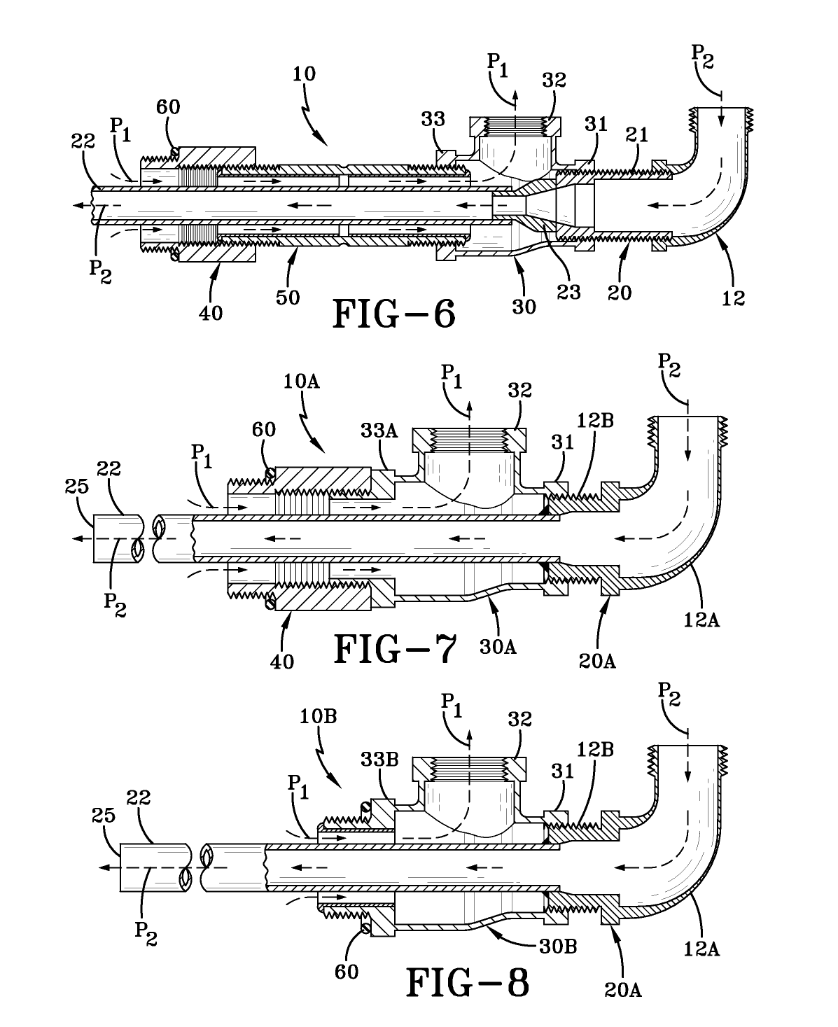

With reference to FIG. 3, an enlarged view is shown showing the hot water tank 2 with the fitting assembly 10 installed. As can be seen, the fitting assembly 10 provides two shut off valves, one shut off valve 6 being connected to the supply side 111 of the solar collector 120 which would deliver water 1 from the storage tank 2 to the solar collector 120 and the other shut off valve 8 being connected directly to the solar hot water return side 112 returning from the solar collector 120 back to the tank 2. As shown, the shut off valve 8 for receiving solar heated water is connected to an elbow 12 to a threaded fitting 20 which is then connected to an end 31 of a T reducer connection 30, the other shut off valve 6 for sending water from the tank 2 to the solar collector 120 is inserted into the center port or end 32 of the T reducer connection 30 directly. At the smaller diameter end 31 of the T reducer connection 30 a specially adapted extended tube fitting 20 is threaded directly into this small end 31 of the T reducer 30. This especially adapted extended tube fitting 20 has a long small tube 22 connected to it extending through the inside of the T reducer 30 and the connection end fitting or nut 40 and extending a substantial distance into the hot water tank 2 as shown. As shown in FIG. 5 the fitting 20 with tube 22 extending was made with a threaded nipple or pipe 21 and a barbed tube fitting 23 soldered or brazed to the inside of the nipple or pipe 21 to make a sealed attachment of the tubing 22 to the barbed tube fitting 23. This tube fitting 23 is then inserted into the smaller diameter end 31 of the T reducer 30 and the elbow 12 and the valve 6 were connected. Connected at the larger end 33 of the T reducer connection fitting 30 is a nipple or threaded at both ends section of pipe 50. One threaded end 51 is connected to the T reducer connection 30 at the larger diameter end 33, the other threaded end 53 is connected to a connection end fitting or nut 40 that has internal pipe threads 42 for accepting the nipple or pipe 50 as shown. On the opposite of the connection end fitting or nut 40 is a rubber O ring seal 60 and standard male threads 44 that are screwed into the threaded opening 4 of the water storage tank 2 that was normally provided for a heating element 80. As this connection end fitting or nut 40 is tightened it draws against the surface of the tank 2 and compresses a rubber O ring seal 60 making a water tight sealing connection. As shown in FIGS. 2 and 6 in cross section, cold water, which naturally goes to the lower end of the tank 2 can flow into and through the connection end fitting 40 around the extending small tube 22 and into the water deliver end 32 of the T fitting connection 30 delivering water up to the solar collector 120 through this first water passageway P₁. Once the water 1 is heated through the solar collector 120 it returns through the elbow 12 through the tube fitting 20 and the T fitting connection 30 and passes inside the tube fitting 20 through the small end 31 of the T reducer connection 30 which is connected to the small inner tube 22, and is released from the second water passageway P₂ at the open end 25 of the small tube 22 which extends a substantial distance into the tank 2. At the end 25 of the tube 22 the hot water 1 is then released into the tank 2 which will naturally rise to the upper portion of the tank 2, in this fashion hot water 1 is always being provided to the tank 2 as the solar collector 120 heats the water 1 to preferably about 180 degrees F. and colder water settles in the lower portions of the tank 2 is delivered to the solar collector 120 to be heated.

A previously discussed, when the sun goes down the pump 122 will shut off eliminating any further delivery of water 1 to the solar collector 120 and preventing the solar collector 120 from effectively cooling the already heated water at night.

With reference to FIGS. 4, 5 and 6; several views of the fitting assembly 10 are shown. In the perspective view of FIG. 4 one can see that the single attachment at the access port 4 location provides the capability of providing both hot and cold water to and from the solar collector 120 as illustrated by employing the fitting assembly 10 of the present invention. Two shut off valves 6, 8 can be provided so the solar system lines 111, 112 can be shut down at any time if so desired. As shown the shut off valves 6, 8 are attached to the fitting assembly 10, alternatively these valves 6, 8 can be installed simply inline separate of the fitting assembly 10 if so desired. FIG. 5 is an exploded view of the various components used to make the fitting assembly 10. The O ring 60, the connection end fitting or nut 40, the nipple 50, the T reducer connection 30, the tube fitting 20, elbow 12 and shut valves 6, 8. At the shut off valves 6 and 8, additional connections are shown including a nipple 9 and a reducer 11 and compression fittings 13 and nuts 14 for connecting to lines 111 and 112, caps 15 and an anti-siphon valve assembly 18 including an upper end 16, a lower end 17 and a check valve 19 interposed between the ends 16, 17. This anti-siphon valve 18 prevents the water in the solar collector 120 from draining back into the tank 2. As shown shut off valves 6 and 8 and the components attached to these valves can be placed in line separate of the dual passageway fitting assembly 10. With particular reference to the inner tube 22 of the tube fitting 20, it is shown that the inner tube 22 extends a substantial distance preferably 4 to 6 inches or more beyond the connection end fitting 40 when attached at the side of the storage tank 2. This is to insure that the solar heated water 1 doesn't simply recirculate within the solar collector 120 but is in fact delivered into the tank 2 a sufficient distance from the inlet passageway P₁ of the dual passageway fitting assembly 10 so that the hot water will rise and the cold or lower temperature water will sink and will be naturally drawn into the fitting assembly 10 through the passageway P₁, this is illustrated in the view of FIG. 3.

With reference to FIG. 6, the cross sectional view of the fitting assembly 10 is shown wherein the fastening of the various components can be seen.

As shown the extended tube fitting 20 has an extended piece of tubing 22, as illustrated this can be a plastic or can be a copper or brass tubing which is attached to a tube connecting fitting 23 which is brazed to the nipple fitting 21 which is connected to the reduced diameter end 32 of the T connector 30. The tube 22 extends across the T connector 30 internally while an end of the threaded nipple fitting 21 engages the reduced pipe threads of end 31 of the T connector 30 as illustrated. A threaded female elbow 12 is shown connected external to the tube fitting 20 with a male end provided to connect to a shut off valve 6 (not shown). This completes the fitting assembly 10 for the hot water receiving side of the dual passageway fitting assembly 10. A nipple 50 is shown encircling and slid over this extended tubing 22 and attached to the larger diameter threaded end 33 of the T reducer connector fitting 30 as illustrated. The end connection fitting 40 with integral nut and a sealing O ring 60 is then attached to the nipple 50 as shown creating the assembly. The end connection fitting 40 has the elastomeric O ring 60 fitted at a standard male thread end 44 that enables the fitting to be put into the opening or access port 4 that was normally provided for a heating element 80. Once tightened, a water tight seal is provided that is secured to the side of the water tank 2. At the center threaded opening 32 of the T reducer connector 30 is a shut off valve 8 which is connected to the line 111 to feed cold or cooler water from the tank 2 to the pump 122 and solar collector 120. Once assembled and connected, the lines 111, 112 form a loop extending from the fitting assembly 10 to the pump 122 and solar collectors 120 back to the fitting assembly 10 having both the returning hot water and the sent colder water passing through the same threaded access port 4 on the water tank 2 yet while being separated by two isolated distinct flow passageways P₁ and P₂, the small hot water outlet passageway P₂ extends well into the tank 2 and a cold water inlet or receiving passageway P₁ encircles the smaller hot water passageway P₂. The geometry and construction of the fitting assembly 10 extended tube 22 insures the heated water 1 moves into the upper portion of the tank 2 and the cooler water 1 is drawn into the fitting assembly 10 to be heated by the solar collectors 120. This fitting assembly 10 allows a standard water tank 2 to be easily adapted for use with solar collectors 120, this avoids any additional cost to the user and enables a highly efficient use of a solar collector 120 in combination with a standard hot water tank 2.

The elimination of the lower electric heating element 80 provides an ideal connection point for the fitting assembly 10 because it is positioned low in the tank 2, but sufficiently well above any sediment particles that accumulate in the tank 2. The sediments such as lime and calcium build up, clog solar collectors and pumps and should be avoided. For this reason the lower drain port 97 available on the tank 2 was avoided as an alternative connection site. The lower drain port 97 is essential to the performance of any water tank 2 and therefore still provides its primary function to flush sediment debris buildup.

With reference to FIG. 7 a first alternative embodiment of the fitting assembly 10A of the present invention is shown. In this alternative embodiment the nipples or threaded pipe 50 can be replaced in such a fashion that the dual passageway “T” fitting 30A can have a male threaded end 33A that inserts directly into the nut of the connection end fitting 40 is shown. By doing this the pipe or nipple extension 50 can be eliminated thus shortening the dual passageway fitting assembly 10A substantially relative to the hot water tank 2. The dual passageway fitting 10A, which has a T reducer fitting 30A as shown having a large male end 33A and a smaller female end 31. At the smaller female end 31 which is provided for the hot water line, the tube 22 that was mounted into a nipple 21 can be mounted directly into an elbow 12A to form the tube fitting 20A as illustrated. The elbow 12A has male pipe threads 12B to fit directly into the end of the T connector fitting 30A as illustrated, by doing this an additional component can be eliminated. This alternative dual passageway fitting assembly 10A is substantially the same as previously discussed and the function is identical. By doing this the dual passageway fitting assembly 10B can eliminate at least two components further reducing the cost. Other modifications can be made further eliminating components if so desired. As shown in both FIGS. 2 and 7 the dual passageway fitting 10 is a T reducer 30 or 30A having approximately a ¾ inch diameter at the large end for receiving the cold water and allowing the tubing extension fitting 22 to pass through, and smaller ends of ⅜ inch diameter typically to provide connections for both the hot water return passageway P₂ and the cold water passage P₁ from the center end 32 of the T connection 30 or 30A as illustrated. These and other modifications can be made to simplify the fitting construction while still enabling the fitting assembly to attach directly to what was previously a heating element 80 connection or access port 4 on an electric hot water tank 2 and yet providing a dual water passageway for both cold and hot water to deliver both to and from the solar collector 120 through the single access port 4.

A second alternative embodiment is shown in FIG. 8 where the dual passageway fitting assembly 10B has the T connection fitting 30B modified having the large diameter end being made with a standard male thread and flange end 33B with the O ring seal 60 attached. This enables this modified “T” connection 30B to be attached directly to the hot water tanks threaded access port 4. All other fittings and attachments can be as shown in the first alternative embodiment of FIG. 7.

The fitting assembly 10 in FIGS. 2 through 6, 10A in FIGS. 7 and 10B in FIG. 8, enables dual electric heater element standard hot water tanks 2 preferably of 40 gallons or more, most preferably 80 gallons or more to be modified in such a fashion that the dual passageway fitting assembly 10, 10A or 10B can be installed directly to a single access port 4 of an electric hot water tank 2. The method of converting a standard water tank 2 to a solar hot water tank includes steps of removing either the upper or lower electrical element 80, preferably the lower heating element 80 from an existing hot water tank 2. Installing the fitting assembly 10, 10B or 10C as previously disclosed into the threaded connection access port 4 on the hot water tank 2 and tightening the fitting assembly 10 to make a water tight seal against the water tank 2, and then connecting the dual passageway fitting assembly 10 to the cold water side 111 and return hot water side 112 of a solar collector system 200. The method may further include adding shut off valves 6, 8 to the fitting assembly 10 enabling the solar collector 120 to be shut down at the fitting assembly 10. Additionally, the method may include adding a mixing valve 140 to the hot water side of the existing water system so that the water temperature within the tank 2 can be provided at elevated temperatures up to approximately 180 degrees F. and the mixing valve 140 can be used to insure that the water delivered to the faucet and showers is provided at a temperature of approximately 120 degrees F. consistently.

By providing the dual passageway fitting assembly 10, 10A or 10B the conversion of existing water tanks 2 enables solar systems to be installed at substantially reduced costs. In practice, the use of the threaded access port 4 that was normally used for heating elements 80 enables the hot water tank 2 as modified to still provide at least one heating element 80 for back up heating while providing a complete single access port for solar heating to be delivered to the water tank 2.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

1. A dual passageway fitting assembly for connection to a hot water tank in a solar hot water system; the fitting assembly comprising;
a fitting assembly internally forming two isolated water passageways, a hot water inflow passageway and a water outflow passageway, the fitting assembly having a connection end to connect water tightly to a single access port on the hot water tank.

2. The dual passageway fitting assembly of claim 1 wherein the connection end is a standard threaded male fitting with integral nut having an internal female pipe thread, the male fitting for connecting directly to standard female threads on the side of a hot water tank.

3. The dual passageway fitting assembly of claim 2 wherein an O ring is placed over the threaded male fitting to water tightly seal the connection end to the water tank.

4. The dual passageway fitting assembly of claim 2 further comprises a first male threaded nipple fitting or threaded pipe fitting connected to the female threads of nut.

5. The dual passageway fitting assembly of claim 4 further comprises a “T” fitting having three ends, a connection end for connection to the first nipple or pipe fitting or the nut directly, a first end for connection to water outflow lines and a second end for hot water inflow lines.

6. The dual passageway fitting assembly of claim 5 further comprises an extended tube fitting, the extended tube fitting has a fitting end for connection to the second end of the T fitting and when assembled has the tube extend internal of the T fitting through the connection end extending a distance (d) beyond the connection end forming the second passageway.

7. The dual passageway fitting assembly of claim 5 wherein the second end has a smaller diameter than the connection end.

8. The dual passageway fitting assembly of claim 6 wherein the extended tube fitting has a threaded nipple or pipe end for attachment to the second end of the “T”.

9. The dual passageway fitting assembly of claim 8 wherein an elbow fitting is attached to the extended tube fitting at the second end of the “T”.

10. The dual passageway fitting assembly of claim 9 wherein a first shut off valve is attached to the first center end of the T.

11. The dual passageway fitting assembly of claim 10 wherein a second shut off valve is connected to the elbow, the combination of the valve and elbow extended tube forming the second internal passageway.

12. The dual passageway fitting assembly of claim 9 wherein the first valve, the T and connection end form the first passageway encircling the second passageway inside the fitting assembly.

13. The dual passageway fitting assembly of claim 6 wherein the extended tube fitting has a tube extended through the “T” fitting, the tube being connected to an elbow, the elbow being attached directly to the “T” fitting.

14. A method of converting an electric hot water tank having dual heating elements to a solar hot water tank comprises the steps of:
removing one of the heating elements;
exposing a threaded access port on the tank; and
installing a dual passageway fitting assembly to the threaded access port of the tank.

15. The method of claim 14 further comprises the step of:
connecting the dual passageway fitting assembly to a solar collector and pump assembly.

16. The method of claim 15 further comprises the step of:
installing a mixing valve to the hot water line of the water tank to permit high temperature water to be delivered at about 120 degrees F.
